(19) United States
(12) Patent Application Publication
(10) Pub. No.: US 2026/0307001 A1
(43) Pub. Date: Oct. 8, 2026

(54) MEMBRANE-ADSORPTION PROCESS FOR DIRECT AIR CAPTURE

(71) Applicant: Ohio State Innovation Foundation, Columbus, OH (US)

(72) Inventors: W.S. Winston HO, Columbus, OH (US); Yang HAN, Columbus, OH (US); Yi-Chen HUANG, Columbus, OH (US)

(21) Appl. No.: 19/485,055

(22) PCT Filed: May 15, 2024
(86) PCT No.: PCT/US2024/029412

§ 371 Date: Nov. 17, 2025

Related U.S. Application Data
(60) Provisional application No. 63/466,619, filed on May 15, 2023.

(51) Int. Cl. B01D 53/22; B01D 53/04; B01D 69/02; B01D 69/12; B01D 71/48; B01D 71/68

(52) U.S. Cl. CPC B01D 53/229; B01D 53/0407; B01D 69/02; B01D 69/12; B01D 71/48; B01D 71/68; B01D 2257/504; B01D 2259/4009

(57) ABSTRACT

Described herein are methods for capturing CO₂ from the air. These methods can combine a solid sorbent-based adsorption process and a single-stage membrane separation process. The method can involve the use of a solid physisorbent such as KAUST-7 in monolithic or powder form to enrich the CO₂ concentration from atmospheric level (around 400 ppm) to about 50%. This desorbed CO₂ stream can then be further purified by a highly CO₂-selective amine-based membrane, where the higher feed CO₂ concentration relaxes the compression requirement. Solid sorbents with different CO₂/N₂ selectivities and membranes with various gas transport properties have been investigated based on the energy consumption and capture cost to demonstrate the effectiveness of the hybrid process.

### CROSS-REFERENCE TO RELATED APPLICATIONS

This application claims benefit of priority of U.S. Provisional Application No. 63/466,619, filed May 15, 2023, which is incorporated herein by reference in its entirety.

### BACKGROUND

Carbon dioxide emissions are the main contributor to climate change. As a result, various technologies have been developed to capture CO₂ from stationary point sources such as fossil fuel-based power plants and industrial processes. Direct air capture (DAC) has recently gained significant interest as it addresses all emissions sources and is not limited by location or size. However, DAC presents challenges due to the ultra-dilute nature of CO₂ in the atmosphere (approximately 418 ppm).

### SUMMARY

Provided herein are systems and methods for direct air capture of carbon dioxide. These methods can combine the use of a solid sorbent-based adsorption process and a single-stage membrane separation process. These methods can involve the use of a solid physisorbent such as KAUST-7 in monolithic or powder form to enrich the CO₂ concentration from atmospheric level (around 400 ppm) to about 50%. This desorbed CO₂ stream can then be further purified by a highly CO₂-selective amine-based membrane, where the higher feed CO₂ concentration relaxes the compression requirement. Solid sorbents with different CO₂/N₂ selectivities and membranes with various gas transport properties have been investigated based on the energy consumption and capture cost to demonstrate the effectiveness of the hybrid process.

For example, in some embodiments, these methods can comprise contacting a sorbent with a gas stream comprising carbon dioxide, thereby absorbing a quantity of carbon dioxide to the sorbent; desorbing the carbon dioxide from the sorbent to generate a CO₂-enriched gas stream; and contacting a facilitated transport membrane with the CO₂-enriched gas stream under conditions effective to afford transmembrane permeation of CO₂ from the CO₂-enriched gas stream.

In some embodiments, the gas stream can comprise CO₂ at a concentration in the range of from 1-1000 ppm. In certain embodiments, the gas stream can comprise ambient air.

In some embodiments, the sorbent comprises a physisorbent. In some embodiments, the sorbent can exhibit a selectivity for CO₂. For example, in certain embodiments, the sorbent can have a CO₂:N₂ selectivity of at least 2 at 25° C. and 1 atm feed pressure.

In some examples, the sorbent can comprise a MOF-based physisorbent (e.g., KAUST-7, HKUST-1, MIL-101, etc.), a zeolitic imidazolate framework, a zeolite, activated carbon, or a combination thereof.

In some embodiments, desorbing the carbon dioxide from the sorbent to generate a CO₂-enriched gas stream can comprise contacting the sorbent with steam.

In some embodiments, the facilitated transport membrane can comprise a support layer, and a selective polymer layer disposed on the support layer. The selective polymer layer can comprise a selective polymer matrix.

The support layer can be a gas permeable layer comprising a gas permeable polymer. The gas permeable polymer can comprise a polyamide, a polyimide, a polypyrrolone, a polyester, a sulfone-based polymer, a polymeric organosilicone, a fluorinated polymer, a polyolefin, a copolymer thereof, or a blend thereof. In some embodiments, the gas permeable polymer can comprise a polyethersulfone. In certain cases, the support layer can comprise a gas permeable polymer disposed on a base (e.g., a nonwoven fabric such as a polyester nonwoven).

The selective polymer matrix can comprise a hydrophilic polymer, a cross-linking agent, amine-containing polymer (a fixed carrier), a mobile carrier, or a combination thereof. In certain cases, the selective polymer matrix can comprise a hydrophilic polymer, a cross-linking agent, amine-containing polymer (a fixed carrier), and a mobile carrier.

In certain embodiments, the selective polymer layer comprises a mobile carrier. The mobile carrier can have a molecular weight of less than 1,000 Da. In some embodiments, the mobile carrier can comprise a low molecular weight amino compound. For example, the mobile carrier can comprise 1,1,3,3-tetramethylguanidine, piperazine-1-carboximidamide, N-methylpiperazine-1-carboximidamide, N-ethylpiperazine-1-carboximidamide, N-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, an amidine with the structure R₁—(C═NH)—NR₂R₃ where each of R₁, R₂, and R₃ groups being H or R═CₙH₂ₙ₊₁ with n ranging from 1 to 10, guanidine with the structure R₁—N(R₂)—(C═NH)—N R₂R₄ where each of R₁, R₂, R₃, and R₄ groups being H or R═CₙH₂ₙ₊₁ with n ranging from 1 to 10, or a combination thereof.

In some embodiments, the selective polymer matrix can comprise a hydrophilic polymer and a cross-linking agent. The cross-linking agent can be selected from the group consisting of formaldehyde, glutaraldehyde, maleic anhydride, glyoxal, divinylsulfone, toluenediisocyanate, trimethylol melamine, terephthalatealdehyde, epichlorohydrin, vinyl acrylate, an aminosilane cross-linking agent, and combinations thereof. The hydrophilic polymer can comprise a polymer selected from the group consisting of polyvinylalcohol, polyvinylacetate, polyethylene oxide, polyvinylpyrrolidone, polyacrylamine, and copolymers thereof, or blends thereof.

In some embodiments, the selective polymer matrix can comprise an amine-containing polymer. The amine-containing polymer can be selected from the group consisting of polyamidine, polyguanidine, polyvinylamine, polyallylamine, polyethylenimine, poly-N-isopropylallylamine, poly-N-tert-butylallylamine, poly-N-1,2-dinethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof.

In some embodiments, the selective polymer layer can further comprise graphene oxide dispersed therein.

The membranes can be used to separate carbon dioxide from gas streams. The membranes can exhibit selective permeability towards gases, such as carbon dioxide. In certain embodiments, the membranes can exhibit a CO₂:N₂ selectivity of at least 50 (e.g., from 50 to 300) at 77° C. and 4 atm feed pressure. In certain embodiments, the membranes can exhibit an CO₂ permeance of at least 750 GPU (e.g., from 750 GPU to 6000 GPU) at 77° C. and 4 atm feed pressure.

Also provided are systems for direct air capture of carbon dioxide. These systems can comprise, for example, a blower configured to direct a gas stream comprising carbon dioxide to a DAC adsorber; a DAC adsorber comprising a sorbent; and a facilitated transport membrane disposed to contact and separate a CO₂-enriched gas stream desorbed from the sorbent present in the DAC adsorber. Examples of such systems are illustrated schematically in FIG. 1.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 schematically illustrates an example membrane-adsorption process for the direct air capture of CO₂.

### DETAILED DESCRIPTION

### Definitions

To facilitate understanding of the disclosure set forth herein, a number of terms are defined below. Unless defined otherwise, all technical and scientific terms used herein generally have the same meaning as commonly understood by one of ordinary skill in the art to which this disclosure belongs. Publications cited herein and the materials for which they are cited are specifically incorporated by reference.

### General Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. Other than where noted, all numbers expressing quantities of ingredients, reaction conditions, geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Accordingly, these terms are intended to not only cover the recited element(s) or step(s), but may also include other elements or steps not expressly recited. Furthermore, as used herein, the use of the terms “a”, “an”, and “the” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. A range may be construed to include the start and the end of the range. For example, a range of 10% to 20% (i.e., range of 10%-20%) can includes 10% and also includes 20%, and includes percentages in between 10% and 20%, unless explicitly stated otherwise herein.

As used herein, the terms “may,” “optionally,” and “may optionally” are used interchangeably and are meant to include cases in which the condition occurs as well as cases in which the condition does not occur. Thus, for example, the statement that a formulation “may include an excipient” is meant to include cases in which the formulation includes an excipient as well as cases in which the formulation does not include an excipient.

A “control” is an alternative subject or sample used in an experiment for comparison purposes. A control can be “positive” or “negative.”

### Chemical Definitions

Terms used herein will have their customary meaning in the art unless specified otherwise. The organic moieties mentioned when defining variable positions within the general formulae described herein (e.g., the term “halogen”) are collective terms for the individual substituents encompassed by the organic moiety. Ph in Formula I refers to a phenyl group.

As used herein, “alkyl” means a straight or branched chain saturated hydrocarbon moieties such as those containing from 1 to 10 carbon atoms. A “higher alkyl” refers to saturated hydrocarbon having 11 or more carbon atoms. A “C₆-C₁₆” refers to an alkyl containing 6 to 16 carbon atoms. Likewise, a “C₆-C₂₂” refers to an alkyl containing 6 to 22 carbon atoms. Representative saturated straight chain alkyls include methyl, ethyl, n-propyl, n-butyl, n-pentyl, n-hexyl, n-septyl, n-octyl, n-nonyl, and the like; while saturated branched alkyls include isopropyl, sec-butyl, isobutyl, tert-butyl, isopentyl, and the like.

As used herein, the term “alkenyl” refers to unsaturated, straight or branched hydrocarbon moieties containing a double bond. Unless otherwise specified, C₂-C₂₄ (e.g., C₂-C₂₂, C₂-C₂₀, C₂-C₁₈, C₂-C₁₆, C₂-C₁₄, C₂-C₁₂, C₂-C₁₀, C₂-C₈, C₂-C₆, or C₂-C₄) alkenyl groups are intended. Alkenyl groups may contain more than one unsaturated bond. Examples include ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl, 1-pentenyl, 2-pentenyl, 3-pentenyl, 4-pentenyl, 1-methyl-1-butenyl, 2-methyl-1-butenyl, 3-methyl-1-butenyl, 1-methyl-2-butenyl, 2-methyl-2-butenyl, 3-methyl-2-butenyl, 1-methyl-3-butenyl, 2-methyl-3-butenyl, 3-methyl-3-butenyl, 1,1-dimethyl-2-propenyl, 1,2-dimethyl-1-propenyl, 1,2-dimethyl-2-propenyl, 1-ethyl-1-propenyl, 1-ethyl-2-propenyl, 1-hexenyl, 2-hexenyl, 3-hexenyl, 4-hexenyl, 5-hexenyl, 1-methyl-1-pentenyl, 2-methyl-1-pentenyl, 3-methyl-1-pentenyl, 4-methyl-1-pentenyl, 1-methyl-2-pentenyl, 2-methyl-2-pentenyl, 3-methyl-2-pentenyl, 4-methyl-2-pentenyl, 1-methyl-3-pentenyl, 2-methyl-3-pentenyl, 3-methyl-3-pentenyl, 4-methyl-3-pentenyl, 1-methyl-4-pentenyl, 2-methyl-4-pentenyl, 3-methyl-4-pentenyl, 4-methyl-4-pentenyl, 1,1-dimethyl-2-butenyl, 1,1-dimethyl-3-butenyl, 1,2-dimethyl-1-butenyl, 1,2-dimethyl-2-butenyl, 1,2-dimethyl-3-butenyl, 1,3-dimethyl-1-butenyl, 1,3-dimethyl-2-butenyl, 1,3-dimethyl-3-butenyl, 2,2-dimethyl-3-butenyl, 2,3-dimethyl-1-butenyl, 2,3-dimethyl-2-butenyl, 2,3-dimethyl-3-butenyl, 3,3-dimethyl-1-butenyl, 3,3-dimethyl-2-butenyl, 1-ethyl-1-butenyl, 1-ethyl-2-butenyl, 1-ethyl-3-butenyl, 2-ethyl-1-butenyl, 2-ethyl-2-butenyl, 2-ethyl-3-butenyl, 1,1,2-trimethyl-2-propenyl, 1-ethyl-1-methyl-2-propenyl, 1-ethyl-2-methyl-1-propenyl, and 1-ethyl-2-methyl-2-propenyl. The term “vinyl” refers to a group having the structure —CH═CH₂; 1-propenyl refers to a group with the structure-CH═CH—CH₃; and 2-propenyl refers to a group with the structure —CH₂—CH═CH₂. Asymmetric structures such as (Z¹Z²)C═C(Z³Z¹) are intended to include both the E and Z isomers. This can be presumed in structural formulae herein wherein an asymmetric alkene is present, or it can be explicitly indicated by the bond symbol C═C.

As used herein, the term “alkynyl” represents straight or branched hydrocarbon moieties containing a triple bond. Unless otherwise specified, C₂-C₂₄ (e.g., C₂-C₂₄, C₂-C₂, C₂-C₁₈, C₂-C₁₆, C₂-C₁₄, C₂-C₁₂, C₂-C₁₀, C₂-C₈, C₂-C₆, or C₂-C₄) alkynyl groups are intended. Alkynyl groups may contain more than one unsaturated bond. Examples include C₂-C₆-alkynyl, such as ethynyl, 1-propynyl, 2-propynyl (or propargyl), 1-butynyl, 2-butynyl, 3-butynyl, 1-methyl-2-propynyl, 1-pentynyl, 2-pentynyl, 3-pentynyl, 4-pentynyl, 3-methyl-1-butynyl, 1-methyl-2-butynyl, 1-methyl-3-butynyl, 2-methyl-3-butynyl, 1,1-dimethyl-2-propynyl, 1-ethyl-2-propynyl, 1-hexynyl, 2-hexynyl, 3-hexynyl, 4-hexynyl, 5-hexynyl, 3-methyl-1-pentynyl, 4-methyl-1-pentynyl, 1-methyl-2-pentynyl, 4-methyl-2-pentynyl, 1-methyl-3-pentynyl, 2-methyl-3-pentynyl, 1-methyl-4-pentynyl, 2-methyl-4-pentynyl, 3-methyl-4-pentynyl, 1,1-dimethyl-2-butynyl, 1,1-dimethyl-3-butynyl, 1,2-dimethyl-3-butynyl, 2,2-dimethyl-3-butynyl, 3,3-dimethyl-1-butynyl, 1-ethyl-2-butynyl, 1-ethyl-3-butynyl, 2-ethyl-3-butynyl, and 1-ethyl-1-methyl-2-propynyl.

Non-aromatic mono or polycyclic alkyls are referred to herein as “carbocycles” or “carbocyclyl” groups. Representative saturated carbocycles include cyclopropyl, cyclobutyl, cyclopentyl, cyclohexyl, and the like; while unsaturated carbocycles include cyclopentenyl and cyclohexenyl, and the like.

“Heterocarbocycles” or “heterocarbocyclyl” groups are carbocycles which contain from 1 to 4 heteroatoms independently selected from nitrogen, oxygen and sulfur which can be saturated or unsaturated (but not aromatic), monocyclic or polycyclic, and wherein the nitrogen and sulfur heteroatoms can be optionally oxidized, and the nitrogen heteroatom can be optionally quaternized. Heterocarbocycles include morpholinyl, pyrrolidinonyl, pyrrolidinyl, piperidinyl, hydantoinyl, valerolactamyl, oxiranyl, oxetanyl, tetrahydrofuranyl, tetrahydropyranyl, tetrahydropyridinyl, tetrahydroprimidinyl, tetrahydrothiophenyl, tetrahydrothiopyranyl, tetrahydropyrimidinyl, tetrahydrothiophenyl, tetrahydrothiopyranyl, and the like.

The term “aryl” refers to aromatic homocyclic (i.e., hydrocarbon) mono-, bi- or tricyclic ring-containing groups preferably having 6 to 12 members such as phenyl, naphthyl and biphenyl. Phenyl is a preferred aryl group. The term “substituted aryl” refers to aryl groups substituted with one or more groups, preferably selected from alkyl, substituted alkyl, alkenyl (optionally substituted), aryl (optionally substituted), heterocyclo (optionally substituted), halo, hydroxy, alkoxy (optionally substituted), aryloxy (optionally substituted), alkanoyl (optionally substituted), aroyl, (optionally substituted), alkylester (optionally substituted), arylester (optionally substituted), cyano, nitro, amino, substituted amino, amido, lactam, urea, urethane, sulfonyl, and, the like, where optionally one or more pair of substituents together with the atoms to which they are bonded form a 3 to 7 member ring.

As used herein, “heteroaryl” or “heteroaromatic” refers an aromatic heterocarbocycle having 1 to 4 heteroatoms selected from nitrogen, oxygen and sulfur, and containing at least 1 carbon atom, including both mono- and polycyclic ring systems. Polycyclic ring systems can, but are not required to, contain one or more non-aromatic rings, as long as one of the rings is aromatic. Representative heteroaryls are furyl, benzofuranyl, thiophenyl, benzothiophenyl, pyrrolyl, indolyl, isoindolyl, azaindolyl, pyridyl, quinolinyl, isoquinolinyl, oxazolyl, isooxazolyl, benzoxazolyl, pyrazolyl, imidazolyl, benzimidazolyl, thiazolyl, benzothiazolyl, isothiazolyl, pyridazinyl, pyrimidinyl, pyrazinyl, triazinyl, cinnolinyl, phthalazinyl, and quinazolinyl. It is contemplated that the use of the term “heteroaryl” includes N-alkylated derivatives such as a 1-methylimidazol-5-yl substituent.

As used herein, “heterocycle” or “heterocyclyl” refers to mono- and polycyclic ring systems having 1 to 4 heteroatoms selected from nitrogen, oxygen and sulfur, and containing at least 1 carbon atom. The mono- and polycyclic ring systems can be aromatic, non-aromatic or mixtures of aromatic and non-aromatic rings. Heterocycle includes heterocarbocycles, heteroaryls, and the like.

“Alkylthio” refers to an alkyl group as defined above with the indicated number of carbon atoms attached through a sulfur bridge. An example of an alkylthio is methylthio, (i.e., —S—CH₃).

“Alkoxy” refers to an alkyl group as defined above with the indicated number of carbon atoms attached through an oxygen bridge. Examples of alkoxy include, but are not limited to, methoxy, ethoxy, n-propoxy, i-propoxy, n-butoxy, s-butoxy, t-butoxy, n-pentoxy, and s-pentoxy. Preferred alkoxy groups are methoxy, ethoxy, n-propoxy, i-propoxy, n-butoxy, s-butoxy, t-butoxy.

“Alkylamino” refers an alkyl group as defined above with the indicated number of carbon atoms attached through an amino bridge. An example of an alkylamino is methylamino, (i.e., —NH—C₃).

“Alkanoyl” refers to an alkyl as defined above with the indicated number of carbon atoms attached through a carbonyl bride (i.e., —(C═O)alkyl).

“Alkylsulfonyl” refers to an alkyl as defined above with the indicated number of carbon atoms attached through a sulfonyl bridge (i.e., —S(═O)₂alkyl) such as mesyl and the like, and “Arylsulfonyl” refers to an aryl attached through a sulfonyl bridge (i.e., — S(═O)₂aryl).

“Alkylsulfamoyl” refers to an alkyl as defined above with the indicated number of carbon atoms attached through a sulfamoyl bridge (i.e., —NHS(═O)₂alkyl), and an “Arylsulfamoyl” refers to an alkyl attached through a sulfamoyl bridge (i.e., — NHS(═O)₂aryl).

“Alkylsulfinyl” refers to an alkyl as defined above with the indicated number of carbon atoms attached through a sulfinyl bridge (i.e. —S(═O)alkyl).

The terms “cycloalkyl” and “cycloalkenyl” refer to mono-, bi-, or tri homocyclic ring groups of 3 to 15 carbon atoms which are, respectively, fully saturated and partially unsaturated. The term “cycloalkenyl” includes bi- and tricyclic ring systems that are not aromatic as a whole, but contain aromatic portions (e.g., fluorene, tetrahydronapthalene, dihydroindene, and the like). The rings of multi-ring cycloalkyl groups can be either fused, bridged and/or joined through one or more spiro unions. The terms “substituted cycloalkyl” and “substituted cycloalkenyl” refer, respectively, to cycloalkyl and cycloalkenyl groups substituted with one or more groups, preferably selected from aryl, substituted aryl, heterocyclo, substituted heterocyclo, carbocyclo, substituted carbocyclo, halo, hydroxy, alkoxy (optionally substituted), aryloxy (optionally substituted), alkylester (optionally substituted), arylester (optionally substituted), alkanoyl (optionally substituted), aryol (optionally substituted), cyano, nitro, amino, substituted amino, amido, lactam, urea, urethane, sulfonyl, and the like.

The terms “halogen” and “halo” refer to fluorine, chlorine, bromine, and iodine.

The term “substituted” refers to a molecule wherein at least one hydrogen atom is replaced with a substituent. When substituted, one or more of the groups are “substituents.” The molecule can be multiply substituted. In the case of an oxo substituent (“═O”), two hydrogen atoms are replaced. Example substituents within this context can include halogen, hydroxy, alkyl, alkoxy, nitro, cyano, oxo, carbocyclyl, carbocycloalkyl, heterocarbocyclyl, heterocarbocycloalkyl, aryl, arylalkyl, heteroaryl, heteroarylalkyl, —NRaRb, —NRaC(═O)Rb, —NRaC(═O)NRaNRb, —NRaC(═O)ORb, —NRaSO₂Rb, —C(═O)Ra, —C(═O)ORa, —C(═O)NRaRb, —OC(═O)NRaRb, —ORa, —SRa, —SORa, —S(═O)₂Ra, —OS(═O)₂Ra and —S(═O)₂ORa. Ra and Rb in this context can be the same or different and independently hydrogen, halogen hydroxyl, alkyl, alkoxy, alkyl, amino, alkylamino, dialkylamino, carbocyclyl, carbocycloalkyl, heterocarbocyclyl, heterocarbocycloalkyl, aryl, arylalkyl, heteroaryl, heteroarylalkyl.

The term “optionally substituted,” as used herein, means that substitution with an additional group is optional and therefore it is possible for the designated atom to be unsubstituted. Thus, by use of the term “optionally substituted” the disclosure includes examples where the group is substituted and examples where it is not.

Reference will now be made in detail to specific aspects of the disclosed materials, compounds, compositions, articles, and methods, examples of which are illustrated in the accompanying Examples and Figures.

### Facilitated Transport Membranes

In some examples, facilitated transport membranes can comprise a gas permeable support layer, and a selective polymer layer disposed on the gas permeable support layer. The gas permeable support layer and the selective polymer layer can optionally comprise one or more sub-layers.

In some embodiments, the membrane can have an CO₂:N₂ selectivity of at least 50 at 77° C. and 4 atm feed pressure. For example, the membrane can have a CO₂:N₂ selectivity of at least 50 (e.g., at least 100, at least 150, at least 200, or at least 250) at 77° C. and 4 atm feed pressure. In some embodiments, the membrane can have a CO₂:N₂ selectivity of 300 or less (e.g., 250 or less, 200 or less, 150 or less, or 100 or less) at 77° C. and 4 atm feed pressure.

In certain embodiments, the membrane can have a CO₂:N₂ selectivity ranging from any of the minimum values described above to any of the maximum values described above. For example, in certain embodiments, the membrane can have a CO₂:N₂ selectivity of from 50 to 300 at 77° C. and 4 atm feed pressure (e.g., from 50 to 250 at 77° C. and 4 atm feed pressure). The CO₂:N₂ selectivity of the membrane can be measured using standard methods for measuring gas permeance known in the art, such as those described in the examples below.

In some embodiments, the membrane can have a CO₂ permeance of at least 750 GPU (e.g., 1000 GPU or greater, 1500 GPU or greater, 2000 GPU or greater, 2500 GPU or greater, 3000 GPU or greater, 3500 GPU or greater, 4000 GPU or greater, 4500 GPU or greater, 5000 GPU or greater, or 5500 GPU or greater) at 77° C. and 4 atm feed pressure.

In some embodiments, the membrane can have a CO₂ permeance of 6000 GPU or less at 77° C. and 4 atm feed pressure (e.g., 5500 CPU or less, 5000 GPU or less, 4500 GPU or less, 4000 GPU or less, 3500 GPU or less, 3000 GPU or less, 2500 GPU or less, 2000 GPU or less, 1500 GPU or less, or 1000 GPU or less).

The CO₂ permeance through the membrane can vary from any of the minimum values described above to any of the maximum values described above. For example, in some embodiments, the membrane can have a CO₂ permeance of from 750 GPU to 6000 GPU at 77° C. and 4 attn feed pressure (e.g., from 1000 GPU to 4500 GPU).

### Gas Permeable Support Layer

The support layer can be formed from any suitable material. The material used to form the support layer can be chosen based on the end use application of the membrane. In some embodiments, the support layer can comprise a gas permeable polymer. The gas permeable polymer can be a cross-linked polymer, a phase separated polymer, a porous condensed polymer, or a blend thereof. Examples of suitable gas permeable polymers include polyamides, polyimides, polypyrrolones, polyesters, sulfone-based polymers, nitrile-based polymers, polymeric organosilicones, fluorinated polymers, polyolefins, copolymers thereof, or blends thereof. Specific examples of polymers that can be present in the support layer include polydimethylsiloxane, polydiethylsiloxane, polydi-iso-propylsiloxane, polydiphenylsiloxane, polyethersulfone, polyphenylsulfone, polysulfone, polyacrylonitrile, polyvinylidene fluoride, polyamide, polyimide, polyetherimide, polyetheretherketone, polyphenylene oxide, polybenzimidazole, polypropylene, polyethylene, partially fluorinated, perfluorinated or sulfonated derivatives thereof, copolymers thereof, or blends thereof. In some embodiments, the gas permeable polymer can be polysulfone or polyethersulfone. If desired, the support layer can include inorganic particles to increase the mechanical strength without altering the permeability of the support layer.

In certain embodiments, the support layer can comprise a gas permeable polymer disposed on a base. The base can be in any configuration configured to facilitate formation of a membrane suitable for use in a particular application. For example, the base can be a flat disk, a tube, a spiral wound, or a hollow fiber base. The base can be formed from any suitable material. In some embodiments, the layer can include a fibrous material. The fibrous material in the base can be a mesh (e.g., a metal or polymer mesh), a woven or non-woven fabric, a glass, fiberglass, a resin, a screen (e.g., a metal or polymer screen). In certain embodiments, the base can include a non-woven fabric (e.g., a non-woven fabric comprising fibers formed from a polyester).

### Selective Polymer Layer

The selective polymer layer can include a selective polymer matrix. The selective polymer matrix can include a hydrophilic polymer, an amine-containing polymer (a fixed-site carrier), a mobile carrier (e.g., a low molecular weight amine or a salt thereof), a cross-linking agent, or a combination thereof.

In some embodiments, the selective polymer layer can be a selective polymer matrix through which CO₂ permeates via diffusion or facilitated diffusion.

### Cross-Linking Agents

The selective polymer matrix can include a cross-linking agent. Cross-linking agents suitable for use in the selective polymer matrix can include, but are not limited to, aminosilane, formaldehyde, glutaraldehyde, maleic anhydride, glyoxal, divinylsulfone, toluenediisocyanate, trimethylol melamine, terephthalatealdehyde, epichlorohydrin, or vinyl acrylate, and combinations thereof.

In some embodiments, the cross-linking agent can include aminosilane. In some embodiments, the cross-linking agent can include aminosilane and glyoxal. The selective polymer matrix can include any suitable amount of the cross-linking agent. For example, the selective polymer matrix can comprise 1 to 70 percent cross-linking agents by weight of the selective polymer matrix. In some embodiments, the cross-linking agent can be at least 30%, at least 35%, at least 40% or at least 50%. In some embodiments, the cross-linking agent can be 40% aminosilane and 20% glyoxal by weight of the selective polymer matrix. In some embodiments, the cross-linking agent can be 35%, aminosilane and 25% glyoxal by weight of the selective polymer matrix.

In some cases, the cross-linking agent can be an aminosilane tetravalent single bonded Si with at least one substituent containing an amino group(s) defined by formula I below

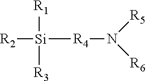

wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl, alkenyl, alkynyl, or alkoxy; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, substituted or unsubstituted alkyl, alkenyl, alkynyl, alkoxy, aryl, heteroaryl, cycloalkyl, or heterocyclyl; or R₅ and R₆, together with the atoms to which they are attached, form a five- or a six-membered heterocycle;
wherein at least one R₁, R₂ or R₃ is a substituted or unsubstituted alkoxy.

In some cases, the cross-linking agent can be an aminosilane of Formula I, wherein R₁-R₃ are each independently selected from hydrogen, substituted or unsubstituted alkyl, alkenyl, alkynyl, alkoxy, aryl, heteroaryl, cycloalkyl, or heterocyclyl; R₄ is selected from substituted or unsubstituted alkyl; and R₅ and R₆ are each independently selected from hydrogen, or substituted or unsubstituted alkyl;
wherein at least one R₁, R₂ or R₃ is a substituted or unsubstituted alkoxy.

### Hydrophilic Polymers

The selective polymer matrix can include any suitable hydrophilic polymer. In some embodiments, the hydrophilic polymer is crosslinked with an aminosilane defined by Formula I. Examples of hydrophilic polymers suitable for use in the selective polymer layer can include polyvinylalcohol, polyvinylacetate, polyethylene oxide, polyvinylpyrrolidone, polyacrylamine, a polyamine such as polyallylamine, polyvinyl amine, or polyethylenimine, copolymers thereof, and blends thereof. In some embodiments, the hydrophilic polymer includes polyvinylalcohol.

The selective polymer matrix can include any suitable crosslinked hydrophilic polymer (e.g., aminosilane crosslinked polyvinyl alcohol).

When present, the hydrophilic polymer can have any suitable molecular weight. For example, the hydrophilic polymer can have a weight average molecular weight of from 15,000 Da to 2,000,000 Da (e.g., from 50,000 Da to 200,000 Da). In some embodiments, the hydrophilic polymer can include polyvinyl alcohol having a weight average molecular weight of from 50,000 Da to 150,000 Da. In other embodiments, the hydrophilic polymer can be a high molecular weight hydrophilic polymer. For example, the hydrophilic polymer can have a weight average molecular weight of at least 500,000 Da (e.g., at least 700,000 Da, or at least 1,000,000 Da).

The selective polymer layer can include any suitable amount of the hydrophilic polymer. For example, in some cases, the selective polymer layer can include from 10% to 90% by weight (e.g., from 10% to 50% by weight, or from 10% to 30% by weight) hydrophilic polymer, based on the total weight of the components used to form the selective polymer layer.

When present, the crosslinked hydrophilic polymer can have any suitable molecular weight. For example, the crosslinked hydrophilic polymer can have a weight average molecular weight of from 15,000 Da to 2,000,000 Da (e.g., from 50,000 Da to 200,000 Da). In some embodiments, the crosslinked hydrophilic polymer can include aminosilane crosslinked polyvinyl alcohol having a weight average molecular weight of from 50,000 Da to 150,000 Da. In other embodiments, the crosslinked hydrophilic polymer can be a high molecular weight crosslinked hydrophilic polymer. For example, the crosslinked hydrophilic polymer can have a weight average molecular weight of at least 500,000 Da (e.g., at least 700,000 Da, or at least 1,000,000 Da).

The selective polymer layer can include any suitable amount of the crosslinked hydrophilic polymer. For example, in some cases, the selective polymer layer can include from 10% to 90% by weight (e.g., from 10% to 50% by weight, or from 10% to 30% by weight) crosslinked hydrophilic polymer, based on the total weight of the components used to form the selective polymer layer.

### Mobile Carriers

The selective polymer matrix can comprise a mobile carrier, such as a low molecular weight amino compound. For example, the mobile carrier can comprise a salt of a primary amine or a salt of a secondary amine.

In some embodiments, the mobile carrier (i.e., the low molecular weight amino compound or a salt thereof) can have a molecular weight of less than 1,000 Da (e.g., 800 Da or less, 500 or less, 300 Da or less, or 250 Da or less). In some embodiments, die mobile carrier can be non-volatile at the temperatures at which the membrane will be stored or used.

In some cases, the mobile carrier can include an amino acid salt. The amino acid salt can be a salt of any suitable amino acid. The amino acid salt may be derived, for instance, from glycine, arginine, lysine, histidine, 6-aminohexanoic acid, proline, sarcosine, methionine, or taurine. In some cases, the amino acid salt can comprise a salt of a compound defined by the formula below

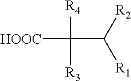

wherein, independently for each occurrence in the amino acid, each of R₁, R₂, R₃ and R₄ is selected from one of the following

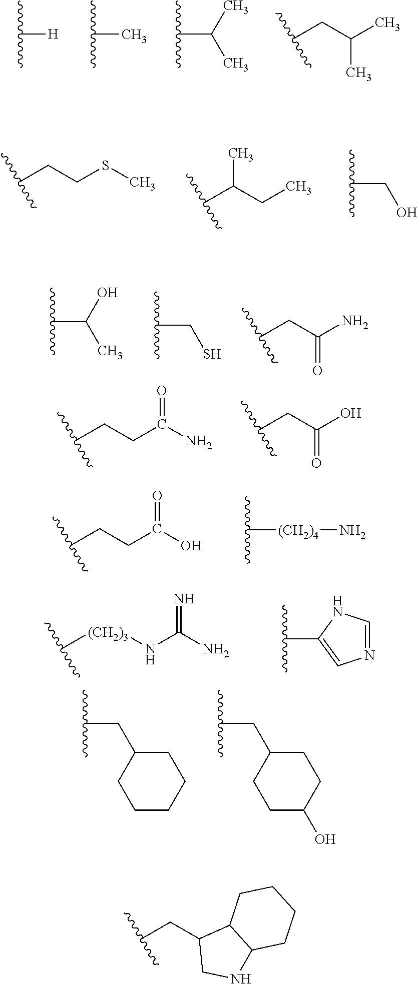

or R₁ and R₃, together with the atoms to which they are attached, form a five-membered heterocycle defined by the structure below when n is 1, or a six-membered heterocycle defined by the structure below when n is 2

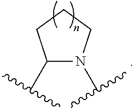

Poly(amino-acids), for example, polyarginine, polylysine, polyonithine, or polyhistidine may also be used to prepare the amino acid salt.

In other embodiments, the mobile carrier can be defined by a formula below

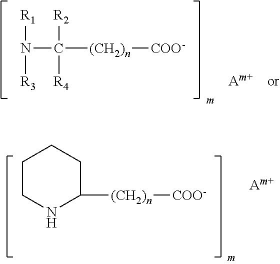

wherein R₁, R₂, R₃, and R₄ are hydrogen or hydrocarbon groups having from 1 to 4 carbon atoms, n is an integer ranging from 0 to 4, A^{m+} is a cation having a valence of 1 to 3. In some cases, the cation (A^{m+}) can be an amine cation having the formula:

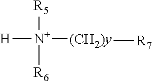

wherein R₅ and R₆ are hydrogen or hydrocarbon groups having from 1 to 4 carbon atoms, R₇ is hydrogen or hydrocarbon groups having from 1 to 4 carbon atoms or an alkyl amine of from 2 to 6 carbon atoms and 1 to 4 nitrogen atoms, y is an integer ranging from 1 to 4, and m is an integer equal to the valence of the cation. In some embodiments, A^{m+} is a metal cation selected from Groups Ia, IIa, and IIIa of the Periodic Table of Elements or a transition metal. For example, A^{m+} can comprise lithium, aluminum, or iron.

Other suitable mobile carriers include aminoisobutyric acid-potassium salt, aminoisobutyric acid-lithium salt, aminoisobutyric acid-piperazine salt, glycine-potassium salt, glycine-lithium salt, glycine-piperazine salt, dimethylglycine-potassium salt, dimethylglycine-lithium salt, dimethylglycine-piperazine salt, piperadine-2-carboxylic acid-potassium salt, piperadine-2-carboxlic acid-lithium salt, piperadine-2-carboxlic acid-piperazine salt, piperadine-4-carboxlic acid-potassium salt, piperadine-4-carboxlic acid-lithium salt, piperadine-4-carboxlic acid-piperazine salt, piperadine-3-carboxlic acid-potassium salt, piperadine-3-carboxlic acid-lithium salt, piperadine-3-carboxlic acid-piperazine salt, and blends thereof.

In some examples, the mobile carrier can be selected from a group consisting of 1,1,3,3-tetramethylguanidine, piperazine-1-carboximidamide, N-methylpiperazine-1-carboximidamide, N-ethylpiperazine-1-carboximidamide, N-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, amidine with the structure R₁—(C≡NTH)—NR₂R₃ where each of R₁, R₂, and R₃ groups being H or R═CₙH₂ₙ₊₁ with n ranging from 1 to 10, guanidine with the structure R₁—N(R₂)—(C═NH)—N R₂R₄ where each of R₁, R₂, R₃, and R₄ groups being H or R═CₙH₂ₙ₊₁ with n ranging from 1 to 10, and a combination thereof

### Amine-Containing Polymers

Optionally, the selective polymer matrix can further include an amine-containing polymer.

In some embodiments, the amine-containing polymer can include one or more primary amine moieties and/or one or more secondary amine moieties. In these embodiments, the amine-containing polymer can serve as an additional “fixed-site carrier.”

The amine-containing polymer can have any suitable molecular weight. For example, the amine-containing polymer can have a weight average molecular weight of from 5,000 Da to 5,000,000 Da, or from 50,000 Da to 2,000,000 Da, or from 2,000,000 Da to 30,000,000 Da. Suitable examples of amine-containing polymers include, but are not limited to, polyamidine, polyguanidine, polyvinylamine, polyallylamine, polyethylenimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof. In some embodiments, the amine-containing polymer can comprise polyvinylamine (e.g., polyvinylamine having a weight average molecular weight of from 500.0 Da to 30,000,000 Da)

### Graphene Oxide

In some embodiments, the selective polymer matrix can further include graphene oxide.

The term “graphene” refers to a one-atom-thick planar sheet of sp2-bonded carbon atoms that are densely packed in a honeycomb crystal lattice. In one embodiment, it refers to a single-layer version of graphite.

The term “graphene oxide” herein refers to functionalized graphene sheets (FGS)—the oxidized compositions of graphite. These compositions are not defined by a single stoichiometry. Rather, upon oxidation of graphite, oxygen-containing functional groups (e.g., epoxide, carboxyl, and hydroxyl groups) are introduced onto the graphite. Complete oxidation is not needed. Functionalized graphene generally refers to graphene oxide, where the atomic carbon to oxygen ratio starts at approximately 2. This ratio can be increased by reaction with components in a medium, which can comprise a polymer, a polymer monomer resin, or a solvent, and/or by the application of radiant energy. As the carbon to oxygen ratio becomes very large (e.g., approaching 20 or above), the graphene oxide chemical composition approaches that of pure graphene.

The term “graphite oxide” includes “graphene oxide”, which is a morphological subset of graphite oxide in the form of planar sheets. “Graphene oxide” refers to a graphene oxide material comprising either single-layer sheets or multiple-layer sheets of graphite oxide. Additionally, in one embodiment, a graphene oxide refers to a graphene oxide material that contains at least one single layer sheet in a portion thereof and at least one multiple layer sheet in another portion thereof. Graphene oxide refers to a range of possible compositions and stoichiometries. The carbon to oxygen ratio in graphene oxide plays a role in determining the properties of the graphene oxide, as well as any composite polymers containing the graphene oxide.

The abbreviation “GO” is used herein to refer to graphene oxide, and the notation GO(m) refers to graphene oxide having a C:O ratio of approximately “in”, where m ranges from 3 to about 20, inclusive. For example, graphene oxide having a C:O ratio of between 3 and 20 is referred to as “GO(3) to GO(20)”, where m ranges from 3 to 20, e.g. m=3, 4, 5, 6, 7, 8, 9, 10, 11, 12, 13, 14, 15, 16, 17, 18, 19 or 20, including all decimal fractions of 0.1 increments in between, e.g. a range of values of 3-20 includes 3.0, 3.1, 3.2, 3.3, 3.4, 3.5, 3.6, 3.7, 3.8, 3.9, 4.0, and so on up to 20. Thus, as used herein, the term GO(m) describes all graphene oxide compositions having a C:O ratio of from 3 to about 20. For example, a GO with a C:O ratio of 6 is referred to as GO(6), and a GO with a C:O ratio of 8, is referred to as GO(8), and both fall within the definition of GO(m).

As used herein, “GO(L)” refers to low C:O ratio graphene oxides having a C:O ratio of approximately “L”, wherein L is less than 3, e.g., in the range of from about 1, including 1, up to 3, and not including 3, e.g. about 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, or about 2.9. In many embodiments, a GO(L) material has a C:O ratio of approximately 2. The designations for the materials in the GO(L) group is the same as that of the GO(m) materials described above, e.g., “GO(2)” refers to graphene oxide with a C:O ratio of 2.

In some embodiments, the graphene oxide can be GO(m). In some embodiments, the graphene oxide can be GO(L). In some embodiments, the graphene oxide can be nanoporous.

### Other Components

In some embodiments, the selective polymer matrix can further include a base. The base can act as a catalyst to catalyze the cross-linking of the selective polymer matrix (e.g., cross-finking of a hydrophilic polymer with an amine-containing polymer). In some embodiments, the base can remain in the selective polymer matrix and constitute a part of the selective polymer matrix. Examples of suitable bases include potassium hydroxide, sodium hydroxide, lithium hydroxide, triethylamine, N,N-dimethylaminopyridine, hexamethyltriethylenetetraamine, potassium carbonate, sodium carbonate, lithium carbonate, and combinations thereof. In some embodiments, the base can include potassium hydroxide. The selective polymer matrix can comprise any suitable amount of the base. For example, the selective polymer matrix can comprise 1 to 40 percent base by weight of the selective polymer matrix.

The selective polymer matrix can further comprise carbon nanotubes dispersed within the selective polymer matrix. Any suitable carbon nanotubes (prepared by any suitable method or obtained from a commercial source) can be used. The carbon nanotubes can comprise single-walled carbon nanotubes, multiwalled carbon nanotubes, or a combination thereof.

In some cases, the carbon nanotubes can have an average diameter of a least 10 nm (e.g., at least 20 nm, at least 30 nm, or at least 40 nm). In some cases, the carbon nanotubes can have an average diameter of 50 nm or less (e.g., 40 nm or less, 30 nm or less, or 20 nm or less). In certain embodiments, the carbon nanotubes can have an average diameter ranging from any of the minimum values described above to any of the maximum values described above. For example, the carbon nanotubes can have an average diameter of from 10 nm to 50 nm (e.g., from 10 nm to 30 nm, or from 20 nm to 50 nm).

In some cases, the carbon nanotubes can have an average length of at least 50 nm (e.g., at least 100 nm, at least 200 nm, at least 300 nm, at least 400 nm, at least 500 nm, at least 600 nm, at least 700 nm, at least 800 nm, at least 900 nm, at least 1 μm, at least 5 μm, at least 10 μm, or at least 15 μm). In some cases, the carbon nanotubes can have an average length of 20 μm or less (e.g., 15 μm or less, 10 μm or less, 5 μm or less, 1 μm or less, 900 nm or less, 800 nm or less, 700 nm or less, 600 nm or less, 500 nm or less, 400 nm or less, 300 nm or less, 200 nm or less, or 100 nm or less).

In certain embodiments, the carbon nanotubes can have an average length ranging from any of the minimum values described above to any of the maximum values described above.

For example, the carbon nanotubes can have an average length of from 50 nm to 20 μm (e.g., from 200 nm to 20 μm, or from 500 nm to 10 μm).

In some cases, the carbon nanotubes can comprise unfunctionalized carbon nanotubes. In other embodiments, the carbon nanotubes can comprise sidewall functionalized carbon nanotubes. Sidewall functionalized carbon nanotubes are well known in the art. Suitable sidewall functionalized carbon nanotubes can be prepared from unfunctionalized carbon nanotubes, for example, by creating defects on the sidewall by strong acid oxidation. The defects created by the oxidant can subsequently converted to more stable hydroxyl and carboxylic acid groups. The hydroxyl and carboxylic acid groups on the acid treated carbon nanotubes can then be coupled to reagents containing other functional groups (e.g., amine-containing reagents), thereby introducing pendant functional groups (e.g., amino groups) on the sidewalls of the carbon nanotubes. In some embodiments, the carbon nanotubes can comprise hydroxy-functionalized carbon nanotubes, carboxy-functionalized carbon nanotubes, amine-functionalized carbon nanotubes, or a combination thereof.

In some embodiments, the selective polymer matrix can comprise at least 0.5% (e.g., at least 1%, at least 1.5%, at least 2%, at least 2.5%, at least 3%, at least 3.5%, at least 4%, or at least 4.5%) by weight carbon nanotubes, based on the total dry weight of the selective polymer matrix. In some embodiments, the selective polymer matrix can comprise 5% or less (e.g., 4.5% or less, 4% or less, 3.5% or less, 3% or less, 2.5% or less, 2% or less, 1.5% or less, or 1% or less) by weight carbon nanotubes, based on the total dry weight of the selective polymer matrix.

The selective matrix layer can comprise an amount of carbon nanotubes ranging from any of the minimum values described above to any of the maximum values described above. For example, the selective polymer matrix can comprise from 0.5% to 5% (e.g., from 1% to 3%) by weight carbon nanotubes, based on the total dry weight of the selective polymer matrix.

If desired, the selective polymer matrix can be surface modified by, for example, chemical grafting, blending, or coating to improve the performance of the selective polymer matrix. For example, hydrophobic components may be added to the selective polymer matrix to alter the properties of the selective polymer matrix in a manner that facilitates greater fluid selectivity.

The total thickness of each layer in the membrane can be chosen such that the structure is mechanically robust, but not so thick as to impair permeability. In some embodiments, the selective polymer layer can have a thickness of from 50 nanometers to 25 microns (e.g., from 100 nanometers to 750 nanometers, from 250 nanometers to 500 nanometers, from 50 nm to 2 microns, from 50 nm to 20 microns, or from 1 micron to 20 microns). In some embodiments, the support layer can have a thickness of from 1 micron to 500 microns (e.g., from 50 to 250 microns). In some cases, the membranes disclosed herein can have a thickness of from 5 microns to 500 microns.

By way of non-limiting illustration, examples of certain embodiments of the present disclosure are given below.

### Examples

### Overview

This example relates to a method that combines a solid sorbent-based adsorption process and a single-stage membrane separation process for capturing CO₂ from the air. The method employs a solid physisorbent such as KAUST-7 in monolithic or powder form to enrich the CO₂ concentration from atmospheric level (around 400 ppm) to about 50%. This desorbed CO₂ stream is then further purified by a highly CO₂-selective amine-based membrane, where the higher feed CO₂ concentration relaxes the compression requirement. Solid sorbents with different CO₂/N₂ selectivities and membranes with various gas transport properties have been investigated based on the energy consumption and capture cost to demonstrate the effectiveness of the hybrid process.

### BACKGROUND

Membrane separation is one of the major technologies for carbon capture because of its energy efficiency and simple operation. Recently, amine-containing facilitated transport membranes (FTMs) have shown exceptional separation performance at operating conditions relevant to removing CO₂ from flue gases (5-15% CO₂) [1-3]. However, applying FTMs for DAC remains challenging because of the significant difference in CO₂ concentrations between stationary source flue gases and air (around a factor of 300 for coal flue gas), and the requirement for a high CO₂ purity (95%) in the product stream for subsequent transportation and sequestration. Additionally, a high degree of air compression is needed to provide the transmembrane driving force, making membrane-based applications prohibitive.

Adsorption processes using various solid sorbents are more widely studied for DAC compared to membrane separation. The generic adsorption DAC system consists of capture and regeneration steps, i.e., in a 2-step process, wherein CO₂ binds to the sorbent first, and then the captured CO₂ is desorbed for multiple cycles. Regeneration energy can be provided either by heat or exposure to vacuum or moisture. However, temperature swings at elevated temperatures (>100° C.) are typically unavoidable for DAC since vacuum swings require a high vacuum level (<0.04 kPa abs) to achieve desorption. Different combinations of temperature, vacuum, and moisture swings can be applied, depending on the type of sorbent [4-6]. Research efforts have been devoted to developing a low-cost sorbent that has large CO₂ uptake (0.5-3.6 mmol/g [7]), high selectivity for CO₂ over competing gases, fast kinetics, and strong physical and chemical stabilities, as well as not overly energy-intensive regeneration. Potential solid sorbents for DAC include supported amine materials, wherein amine functional groups are anchored to the surface of cellulose [8,9], porous silicas [10,11], or metal-organic frameworks (MOFs) [7,12]. However, the cyclic stabilities of these sorbents need further investigation to overcome amine loss and sorbent degradation [13,14]. Physisorbents, typically more physically and chemically stable than chemisorbents, are less studied for DAC since they fail to meet the requirements for high CO₂ selectivity over N₂ and H₂O, which are major components of the air [15,16].

The solid sorbent-based DAC process usually requires approximately 80% thermal and 20% electrical energy [17]. The thermal energy comes from the heat needed for regeneration, while the electrical energy results from the blowers to overcome the pressure drop and the vacuum pump to remove residual air after adsorption and evacuate the unit during desorption. Several parameters, such as the sorbent CO₂ working capacity, sorbent lifetime, adsorption-desorption cycle time, required vacuum pressure, and regeneration temperature impact the capture cost. The higher the working capacity, the less sorbent is needed to capture the same amount of CO₂. The sorbent lifetime mainly affects the variable cost with the repeated sorbent purchase, so a longer lifetime is more favorable. Fast adsorption-desorption cycling implies that less sorbent is needed for the same output. Lastly, the regeneration temperature directly relates to the required thermal energy, and the sensible heat of the process should be minimized. Glebald et al. [18] used the steam-assisted vacuum desorption process for DAC, where the blower pushes air through the adsorption unit and CO₂ is adsorbed at ambient conditions. Once the sorbent reaches the desired uptake, the vacuum pump pulls evacuation (20-400 mbar abs), and steam is purged under vacuum for desorption (typically at temperatures of 80-130° C.). The desorbed CO₂ is then separated from water by condensation. Meanwhile, the adsorption unit is re-pressurized to ambient atmospheric pressure conditions, and the sorbent is cooled before the adsorption process is restarted.

### Proposed Hybrid Processes for CO₂ Capture

Provided herein is a membrane-adsorption hybrid process for capturing CO₂ from an air stream. The feed air stream contains CO₂ and other constituents such as N₂, H₂O and O₂. The hybrid process includes a less CO₂-selective yet robust physisorbent material that first enriches the CO₂ concentration to a certain level. The desorbed CO₂ stream (with residual air) is then further purified by a high CO₂-selective membrane, i.e., a FTM.

In the adsorption section, a variety of suitable physisorbents can be used. In this example, a MOF-based physisorbent (KAUST-7, also known as NbOFFIVE-1-Ni [19,20]) with a fair CO₂/N₂ selectivity (CO₂:N₂=5.6:1 by mole) and good water stability is modeled to apply for the above-described process. However, the solid physisorbent can be any suitable physisorbent, such as KAUST-7 (also known as NbOFFIVE-1-Ni [19,20]), a porous-framework material having the formula [Cu₃(btc)₂(H₂O)₃] (also known as HKUST-1), MIL-101 (a large-cavity MOF having the formula [Cr₃F(H₂O)₂O(BDC)₃]), a zeolitic imidazolate framework (ZIFs, e.g. ZIF-4 and ZIF-8), a zeolitic material (e.g., ZSM-5 (MFI) and Faujasite), and activated C.

Likewise, any suitable FTM can be utilized in the membrane section. In some examples, a polymeric FTM including a CO₂ selective layer, gas permeable support layer, and a mechanical support layer can be used. For example, the membrane can contain a high molecular weight polyvinylamine that acts as a fixed-site carrier for CO₂. Various amino acid salts can also be incorporated as mobile carriers, facilitating CO₂ transport and achieving high CO₂/N₂ selectivity [21,22]. By way of example, the membrane can be a facilitated transport membrane (FTM) containing a selective layer comprising polyamidine and 2-(1-piperazinyl)ethylamine sarcocinate (PZEA-Sar), polyguanidine and PZEA-Sar, polyamidine, polyguanidine, polyvinylamine (PVAm) and tetramethyl guanidine, or PVAm and PZEA-Sar.

In this example, the hybrid process is compared favorable to the adsorption-alone process since it would not only relax the compression requirement for dilute CO₂ separation by the membrane process but also alleviate the concerns about uncompetitive cost and relatively low stability (i.e., shorter lifetime) of cheniisorbents, which are required for adsorption capacity. The technical approaches include process modeling as well as energy and economic analyses.

### General Methods

The basis for the calculations is detailed below.

The physical properties of solid sorbent (KAUST-7) are shown in Table 1, while the gas transport properties of the amine-based membrane are shown in Table 2.

TABLE 1
KAUST-7 sorbent properties.

| | |
|---|---|
| Specific heat (kJ/kg/K) | 0.75 |
| Bulk density (kg/m³) | 600 |
| Heat of CO₂ desorption (kJ/mol) | 54 |
| Heat of N₂ desorption (kJ/mol) | 12 |
| Heat of H₂O desorption (kJ/mol) | 50 |

TABLE 2
Membrane transport properties.

| | CO₂ permeance | | | |
|---|---|---|---|---|
| Material | (GPU) | CO₂:N₂ | CO₂:H₂O | CO₂:O₂ |
| Amine-based | 1100 | 100 | 1 | 100 |

All calculations were based on a net 100,000 tonnes of carbon dioxide captured annually from the atmosphere by adjusting the air inlet flow rates. In the following embodiments, the air feed stream at ambient conditions (25° C., 1 bar, and 25% relative humidity) includes 0.04 mol % CO₂, 78.16 mol % N₂, 1.07 mol % H₂O and balanced with O₂. All calculations were performed with a modeling code in MATLAB. A COMSOL® program was applied to solving adsorption operations, which assumed a single two-dimensional channel within a monolith structure to simulate the concentration and temperature dynamics of the temperature-swing adsorption process [23]. A membrane stage (MB) was modeled as a cross-flow configuration in MATLAB®. All blowers, compressors and turbo expanders were assumed to be 85% efficiency. For all cases, at least 95% CO₂ purity on a dry basis was achieved.

### Example 1. An Example of Membrane-Adsorption Hybrid Process

An example of membrane-adsorption hybrid process combines a solid-based adsorption process with a single-stage membrane process for direct air capture. The air stream flows to the DAC adsorber (monolith structure) coated with a moderate CO₂/N₂ selective sorbent material film. After the adsorption step ends, steam is injected into adsorber to regenerate the adsorbed gases. The desorbed gases and remaining air then flow to a crossflow membrane stage employing a membrane with high CO₂ permeance and CO₂/N₂ selectivity. This process shows a favorable cost for CO₂ capture from the air.

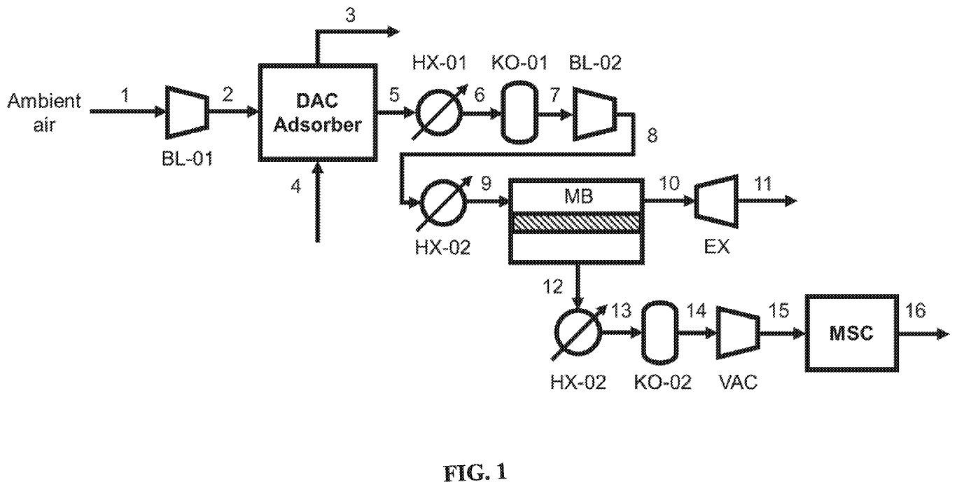

The hybrid process integrating an adsorption section and a single-stage membrane section is shown schematically in FIG. 1. In the adsorption section, air with 400 ppm of CO₂ (Stream 1) passes through the DAC adsorber by blower BL-01 (Stream 2) at ambient conditions. CO₂, N₂ and H₂O in the air are adsorbed by the sorbent film, while 02 is usually not or to a lesser extent. Once the desired level of CO₂ loading is reached, the air stream is stopped and saturated steam (Stream 4) is purged at a constant flow rate into the adsorber at a desorption temperature of 100° C. The residual air and desorbed gases with enriched CO₂ concentration (around 50 mol % on wet basis) are subsequently sent into cooler HX-01 and water knockout KO-01 to condense the water. Then the gas is pressurized by compressor BL-02 to about 3 atm. The pressurized gas (Stream 8) is cooled to 77° C. and passes to the highly CO₂-selective membrane stage MB. Afterward, the permeate stream (Stream 11) goes through after-cooler HX-03 and water knockout KO-02 and is discharged by a vacuum pump VAC in the 150-200 torr range. Usually, the feed-to-permeate pressure ratio is around 15 and at least 95% of CO₂ purity on a dry basis is achieved. Due to the high CO₂/N₂ selectivity of MB, a high CO₂ removal and purity can be achieved by applying a large pressure ratio. Finally, Stream 15 is ready for CO₂ compression to about 2215 psia by an 8-stage compressor MSC for subsequent transportation and sequestration.

A steam generation boiler produces saturated steam (Stream 4) from liquid water. Stream 3 as treated air is vented, and Stream 10 passes a turbo-expander EX to recover part of the compression energy.

### Example 2. Membrane-Adsorption Hybrid Process Modeling

A calculation was performed to illustrate the CO₂ capture from the air using KAUST-7 as the DAC adsorber and an amine-based membrane for the MB membrane stage. In the adsorption section, the air inlet velocity of 1.5 n/s and the steam velocity of 0.025 m/s were applied. The adsorption time (1540 s) was assumed to be the time that a CO₂ adsorption uptake value reached 90% of the maximum value, ensuring that a certain amount of gaseous CO₂ was captured. The desorbed gases including CO₂, N₂ as well as purged steam and residual air made up a stream with enriched CO₂ concentration (at least 50 mol % on wet basis). Higher enriched CO₂ concentrations can be attained by extending the desorption time. In the membrane section, it was assumed that the feed gas to the membrane stage was compressed to 3 atm, and the vacuum pump provided a vacuum of 150 torr. The results of the calculation are shown in Table 3.

TABLE 3
Calculation results for the hybrid process.
Stream

| | | | | | |
|---|---|---|---|---|---|
| Stream/Parameter | 1 | 6 | 8 | 10 | 16 |
| Pressure (atm) | 1 | 1.0 | 1.0 | 3.0 | 0.2 |
| Temperature (° C.) | 25 | 100 | 25 | 77 | 136 |
| Flow rate (mol/s) | 497,568 | 2415 | 139 | 87 | 87 |

Component (mol %)

| | | | | | |
|---|---|---|---|---|---|
| CO₂ | 0.04 | 3.33 | 52.44 | 52.44 | 79.98 |
| N₂ | 78.16 | 1.91 | 30.07 | 30.07 | 3.59 |
| H₂O | 1.07 | 94.41 | 12.15 | 12.15 | 15.79 |
| O₂ | 20.73 | 0.34 | 5.35 | 5.35 | 0.64 |

The economic modeling was conducted in a similar manner as Case 0B-EB in the DOE's direct air capture case studies [24] except that the evaluation of the steam cost was calculated based on the steam usage and the unit steam cost [23,25]. The cyclic capacities of gases, membrane areas, and energy consumptions along with the capture cost and capture rate are as follows:

$${CO}_{2} cyclic capactiy = 0.69 mmol / g$$

$${N}_{2} cyclic capactiy = 0.12 mmol / g$$

$${H}_{2} O cyclic capactiy = 1.58 mmol / g$$

$$MB membrane area = 4.1 \times {10}^{3} {m}^{2}$$

$$Total thermal energy demand = 2340 kWh / tonne {CO}_{2}$$

$$Total electrical energy demand = 276 kWh / tonne {CO}_{2}$$

$$Capture cost = \$363 / tonne {CO}_{2}$$

$$Capture rate = 39.5 \%$$

This example showed the present invention of the membrane-adsorption process can capture CO₂ from air directly and effectively.

There are several features of the present invention. Firstly, by employing a physisorbent (KAUST-7) in the adsorption section, N₂ apart from CO₂ is also adsorbed, diluting the CO₂ concentration of the product stream. However, utilizing physisorbents with moderate CO₂ adsorption heats (usually <60 kJ/mol CO₂) reduces the thermal energy demand for desorption. For example, an around 5% increase in energy consumption demonstrates if a chemisorbent (e.g., amine-supported materials) with a similar adsorption capacity but higher CO₂ adsorption heat (70 kJ/mol) is applied. Secondly, the co-adsorption of H₂O and steam condensation during the steam purge step release heat for regeneration, lowering the needed steam usage. It should be noted that the competitive adsorption of H₂O for physisorbents impacts the capability of CO₂ adsorption negatively. Thus, physisorbents with higher water stability are desirable for the process. Thirdly, the evacuation after the desorption step to avoid dilution from remaining air is not required since the successive MB with a amine-based membrane can afford a certain range of CO₂ concentration. Fourthly, due to the significantly lower flow rate in the membrane section compared to the adsorption section, the energy and cost components contributed from the membrane section only account for 3% and 5%, respectively. Fifthly, the physisorbent is expected to have a longer lifetime in contrast to the chemisorbent, leading to a lower capture cost since variable cost from the adsorbent constitutes a significant proportion (34%) of the capture cost.

### Example 3. Effect of Intrinsic Properties of Sorbent

A calculation was performed to illustrate the CO₂ capture from atmospheric air using the membrane-adsorption hybrid process by adjusting the adsorption CO₂/N₂ selectivity (CO₂:N₂ by mole) of physisorbents. In this example, various molar ratios of CO₂:N₂ (3:1, 1:1 and 1:2) for the physisorbents in DAC adsorber were modeled while keeping the same amine-based membrane in MB under the same operating conditions. It was assumed that all the adsorption properties of physisorbents kept the same as the KAUST-7. Only the N₂ cyclic capacity was altered to obtain different molar ratios. The enriched CO₂ concentrations by the prior adsorption process reduced from 52.4 to 47.6, 34.9 and 24.6 mol %, respectively. The respective capture costs accordingly increased to $364 ($364.37 more exactly), $387 and $482/tonne CO₂ because of the lower CO₂ recovery under the same compression ratio in MB. By using an amine-based membrane with a higher CO₂/N₂ selectivity (e.g., 140), the capture costs of these three cases can be further lowered to $364 ($364.45 more exactly), $375 and $416/tonne CO₂. Consequently, the membrane-adsorption hybrid process can make use of the physisorbent with modest CO₂/N₂ selectivity by integrating high CO₂-selective amine-based membranes for direct air capture. It should be noted that a particular value of CO₂ cyclic capacity is required to prevent the excessive usage of the adsorbent. For example, reducing the CO₂ cyclic capacity of the physisorbent by one-half (i.e., 0.35 mmol/g) while keeping the same CO₂/N₂ selectivity led to an increase in capture cost of $212/tonne CO₂. On the contrary, increasing the CO₂ cyclic capacity of the physisorbent by a factor of two (i.e., 1.37 mmol/g) resulted in a 31% reduction of capture cost ($251/tonne CO₂). These results indicate the importance of the adsorbent CO₂ cyclic capacity.

### Example 4. Effect of Intrinsic Properties of Membrane

A calculation was performed to illustrate the DAC using the membrane-adsorption hybrid process by adjusting the gas transport properties (CO₂ permeance and CO₂/N₂ selectivity) of membranes. In this example, various CO₂ permeances (500, 1500, and 2000) of the membrane in MB were used while keeping the CO₂/N₂ selectivity of 100. The capture costs varied with the required membrane areas; however, the differences in capture costs were limited to 0.8%. Reducing the CO₂ permeance of the membrane by about one-half only led to an increase in capture cost of $1/tonne CO₂. In addition, various CO₂/N₂ selectivities (20, 50 and 140) of the membrane were applied while keeping the CO₂ permeance of 1100 GPU. A reduced membrane CO₂/N₂ selectivity increased capture cost due to a lower CO₂ recovery. For example, reducing the CO₂/N₂ selectivity from 100 to 20 caused a 42% increase in capture cost. However, increasing the selectivity from 100 to 140 did not further improve the capture cost unless the pressure ratio of MB increased. Consequently, the requirement of the membrane in MB is the high CO₂/N₂ selectivity, which provides a high CO₂ removal and therefore leads to a competitive capture cost.

### Example 5. Shaping of KAUST-7 material from powders to granules

KAUST-7 (NbOFFVE-1-Ni, NiNbOF₅(pyrazine)₂-2H₂O), a fluoridated metal-organic framework, exhibits a CO₂ adsorption capacity of 1.3 mmol/g under 400 ppm at 298 K and offers a moderate desorption energy of 54 kJ/mol (typically below 60 kJ/mol for highly CO₂-selective physisorbents). The good hydrolytic stability of this material makes it possible to be applied in practical humid conditions, apart from other physisorbents.

The synthesis of KAUST-7 was conducted through the solvothermal reaction procedure [19]. Since the powdery materials are limited in practical applications, the KAUST-7 powders were shaped with binders (poly(methyl methacrylate (PMMA) and silica) via granulation for the subsequent application. For PMMA as the binder, 0.1 g of PvIMA was first dissolved in 3.0 mL (4.47 g) of chloroform and stirred until the solution turned clear. Then, 0.925 g of as-synthesized KAUST-7 powders were suspended in 3.0 mL (4.47 g) of chloroform and mixed with 3.43 g of the above binder solution (8.825 g for the total mixture). For silica as the binder, 0.1875 g of 40 wt. % silica sol was added in 3.0 mL of DI water and stirred until the solution mixed well. Then, 0.925 g of as-synthesized KAUST-7 powders were suspended in 3.0 mL of DI water and mixed with 2.39 g of the above binder solution (6.315 g for the total mixture). After stirring and sonicating for 10 min, each of the mixtures was purged with N₂ to remove the excess solvent to form a cake-like rigid body, which was then dried at 105° C. in an Argon purge oven, respectively. The respective resultant materials were ground and sieved into a particle size range of 180-250 μm, which were the KAUST-7 granules with the 7.5 wt. % loading of PMMA and silica, respectively.

To evaluate the potentials of KAUST-7 granules with 7.5 wt. % PMMA and silica as suitable adsorbent materials for air capture, mixed-gas breakthrough experiments were performed under conditions similar to the real-world CO₂ level. Also, the same experimental protocol was used for the powders without shaping for comparison. The breakthrough experiments under 400 ppm of CO₂ in N₂ were conducted with a feed flow rate of 20 sccm. The determined CO₂ uptakes for granules bound with PMMA and silica were 1.21 and 1.26 mmol/g, respectively, which were around 14 and 12% lower than the powdered form (1.42 mmol/g).

### REFERENCES

[1] Y. Han, W. S. W. Ho, Polymeric membranes for CO₂ separation and capture, Journal of Membrane Science, 628 (2021), 119244.
[2] Y. Han, D. Wu, W. S. W. Ho, Nanotube-reinforced facilitated transport membrane for CO₂/N₂ separation with vacuum operation, Journal of Membrane Science, 567 (2018) 261-271.
[3] Y. Han, W. Salim, K. K. Chen, D. Wu, W. S. W. Ho, Field trial of spiral-wound facilitated transport membrane module for CO₂ capture from flue gas, Journal of Membrane Science, 575 (2019) 242-251.
[4] H. Azarabadi, K. S. Lackner, A sorbent-focused techno-economic analysis of direct air capture, Applied Energy, 250 (2019) 959-975.
[5]P. Bollini, S. A. Didas, C. W. Jones, Amine-Oxide Hybrid Materials for Acid Gas Separations, Journal of Materials Chemistry, 21 (2011), 15100-15120.
[6] R. P. Wijesiri, G. P. Knowles, H. Yeasmin, A. F. A. Hoadley, A. L. Chaffee, Desorption Process for Capturing CO₂ from Air with Supported Amine Sorbent, Industrial & Engineering Chemistry Research, 58 (2019) 15606-15618.
[7] D. G. Madden, H. S. Scott, A. Kumar, K. J. Chen, R. Sanii, A. Bajpai, M. Lusi, T. Curtin, J. J. Perry, M. J. Zaworotko, Flue-Gas And Direct-Air Capture of CO₂ by Porous Metal-Organic Materials, Phil. Trans. R. Soc. A (Math. Phys. Eng. Sci.), 375 (2016), 0025-0035.
[8] J. A. Wurzbacher, C. Gebald, N. Piatkowski, A. Steinfeld, Concurrent Separation of CO₂ and H₂O from Air by a Temperature-Vacuum Swing Adsorption/Desorption Cycle, Environ. Sci. Technol., 46 (2012) 9191-9198.
[9] C. Gebald, J. A. Wurzbacher, P. Tingaut, A. Steinfeld, Stability of Amine-Functionalized Cellulose during Temperature-Vacuum-Swing Cycling for CO₂ Capture from Air, Environ. Sci. Technol., 47 (2013) 10063-10070.
[10] J.-T. Anyanwu, Y. Wang, R. T. Yang, Amine-Grafted Silica Gels for CO₂ Capture Including Direct Air Capture, Industrial & Engineering Chemistry Research, 59 (2019) 7072-7079.
[11] N. R. Stuckert, R. T. Yang, CO₂ Capture from the Atmosphere and Simultaneous Concentration Using Zeolites and Amine-Grafted SBA-15, Environ. Sci. Technol. 45 (2011) 10257-10264.
[12] H. Zhang, A. Goeppert, G. K. S. Prakash, G. Olah, Applicability of Linear Polyethylenimine Supported on Nano-Silica for the Adsorption of CO₂ from Various Sources Including Dry Air, RSC Advances, 5 (2015), 52550-52562.
[13] A. Heydari-Gorji, Y. Belmabkhout, A. Sayari, Degradation of Amine-Supported CO₂ Adsorbents in the Presence of Oxygen-Containing Gases, Microporous and Mesoporous Materials, 145 (2011), 146-149.
[14] S. Bali, T. T. Chen, W. Chaikittisilp, C. W. Jones, Oxidative Stability of Amino Polymer-Alumina Hybrid Adsorbents for Carbon Dioxide Capture, Energy & Fuels, 27 (2013), 1547-1554.
[15] J. M. Kolle, M. Fayaz, A. Sayari, Understanding the Effect of Water on CO₂ Adsorption, Chem. Rev., 121 (2021), 7280-7345.
[16]S. M. W. Wilson, F. H. Tezel, Direct Dry Air Capture of CO₂ Using VTSA with Faujasite Zeolites, Industrial & Engineering Chemistry Research, 59 (2020) 8783-8794.
[17] N. McQueen, K. V. Gomes, C. McCormick, K. Bilumanthal, M. Pisciotta, J. Wilcox, A review of direct air capture (DAC): scaling up commercial technologies and innovating for the future, Progress in Energy, 3 (2021), 032001.
[18] C. Gebald, N. Repond, J. A. Wurzbacher, Steam Assisted Vacuum Desorption Process for Carbon Dioxide Capture, U.S. Patent Application Publication No. US 2017/0203249, Jul. 20, 2017, related to U.S. Pat. No. 10,279,306, May 7, 2019.
[19] P. M. Bhatt, Y. Belmabkhout, A. Cadiau, K. Adil, O. Shekhah, A. Shkurenko, L. J. Barbour, M. Eddaoudi, A Fine-Tuned Fluorinated MOE Addresses the Needs for Trace CO₂ Removal and Air Capture Using Physisorption, J. Am. Chem. Soc., 138 (2016), 9301-9307.
[20] M. Guo, H. Wu, L. Lv, H. Meng, J. Yun, J. Jin, J. Mi, A Highly Efficient and Stable Composite of Polyacrylate and Metal-Organic Framework Prepared by Interface Engineering for Direct Air Capture, ACS App. Mater. Interfaces, 1 (2021), 21775-21785.
[21] Z. Zhang, S. Rao, Y. Han, R. Pang, W. S. W. Ho, CO₂—Selective Membranes Containing Amino Acid Salts for CO₂/N₂ Separation, Journal of Membrane Science, 638 (2021), 119696.
[22] T.-Y. Chen, X. Deng, L.-C. Lin, and W. S. W. Ho, ¹³C NMR Study of Amino Acid Salts in Facilitated Transport Membranes for Post-Combustion Carbon Capture, Journal of Membrane Science, 671 (2023), 121309.
[23] A. Sinha, L. A. Darunte, C. W. Jones, M. J. Realff, Y. Kawajiri, Systems Design and Economic Analysis of Direct Air Capture of CO₂ through Temperature Vacuum Swing Adsorption Using MIL-101(Cr)-PEI-800 and mmen-Mg2(dobpdc) MOF Adsorbents, Industrial & Engineering Chemistry Research, 56 (2017), 750-764.
[24] J. Valentine, A. Zoelle, S. Honsy, H. Mantripragada, M. Woods, N. Roy, A. Kilstofte, M. Sturdivan, M. Steutermann, T. Fout, Direct Air Capture Case Studies: Sorbent System, U.S. Department of Energy, Office of Scientific and Technical Information (OSTI), OSTI ID 1887383, Aug. 16, 2022.
[25] A. Sinha, M. J. Realff, A Parametric Study of the Techno-Economics of Direct CO₂ Air Capture Systems Using Solid Adsorbents, Aiche Journal, 65 (2019), e16607.

The systems and methods of the appended claims are not limited in scope by the specific systems and methods described herein, which are intended as illustrations of a few aspects of the claims and any systems and methods that are functionally equivalent are intended to fall within the scope of the claims. Various modifications of the systems and methods in addition to those shown and described herein are intended to fall within the scope of the appended claims. Further, while only certain representative systems components and method steps disclosed herein are specifically described, other combinations of the components and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated.

What is claimed is:

1. A method for direct air capture of carbon dioxide, the method comprising:
contacting a sorbent with a gas stream comprising carbon dioxide, thereby absorbing a quantity of carbon dioxide to the sorbent;
desorbing the carbon dioxide from the sorbent to generate a CO₂-enriched gas stream; and
contacting a facilitated transport membrane with the CO₂-enriched gas stream under conditions effective to afford transmembrane permeation of CO₂ from the CO₂-enriched gas stream.

2. The method of claim 1, wherein the facilitated transport membrane is selectively permeable to carbon dioxide.

3. The membrane of any of claims 1-2, wherein the facilitated transport membrane has a CO₂:N₂ selectivity of at least 50 at 77° C. and 4 atm feed pressure.

4. The membrane of any of claims 1-3, wherein the facilitated transport membrane has a CO₂:N₂ selectivity of from 50 to 300 at 77° C. and 4 atm feed pressure.

5. The membrane of any of claims 1-4, wherein the facilitated transport membrane has a CO₂ permeance of at least 750 GPU at 77° C. and 4 atm feed pressure.

6. The membrane of any of claims 1-5, wherein the facilitated transport membrane has a CO₂ permeance of from 750 GPU to 6000 GPU at 77° C. and 4 atm feed pressure.

7. The method of claims 1-6, wherein the facilitated transport membrane comprises:
a support layer; and
a selective polymer layer disposed on the support layer, the selective polymer layer comprising a selective polymer matrix.

8. The method of any of claims 1-7, wherein the selective polymer matrix comprises a hydrophilic polymer, a cross-linking agent, amine-containing polymer, a mobile carrier, or a combination thereof.

9. The method of claim 8, wherein the selective polymer layer comprises a mobile carrier.

10. The method of claim 9, wherein the mobile carrier has a molecular weight of less than 1,000 Da.

11. The method of any of claims 8-10, wherein the mobile carrier comprises a low molecular weight amino compound.

12. The method of any of claims 8-11, wherein the mobile carrier comprises 1,1,3,3-tetramethylguanidine, piperazine-1-carboximidamide, N-methylpiperazine-1-carboximidamide, N-ethylpiperazine-1-carboximidamide, N %-propylpiperazine-1-carboximidamide, N-butylpiperazine-1-carboximidamide, N-pentylpiperazine-1-carboximidamide, N-hexylpiperazine-1-carboximidamide, N-heptylpiperazine-1-carboximidamide, N-octylpiperazine-1-carboximidamide, 2-(1-piperazinyl)ethylamine sarcosinate, 2-(1-piperazinyl)ethylamine glycinate, 2-(1-piperazinyl)ethylamine aminoisobutyrate, piperazine sarcosinate, piperazine glycinate, piperazine aminoisobutyrate, lithium sarcosinate, lithium glycinate, lithium aminoisobutyrate, potassium sarcosinate, potassium glycinate, potassium aminoisobutyrate, an amidine with the structure R₁—(C═NH)—NR₂R₃ where each of R₁, R₂, and R₃ groups being H or R═CₙH₂ₙ₊₁ with n ranging from 1 to 10, guanidine with the structure R₁—N(R₂)—(C═NH)—N R₂R₄ where each of R₁, R₂, R₃, and R₄ groups being H or R═CₙH₂ₙ₊₁ with n ranging from 1 to 10, or a combination thereof.

13. The method of any of claims 8-12, wherein the selective polymer matrix comprises a hydrophilic polymer and a cross-linking agent.

14. The method of claim 13, wherein the cross-linking agent is selected from the group consisting of formaldehyde, glutaraldehyde, maleic anhydride, glyoxal, divinylsulfone, toluenediisocyanate, trimethylol melamine, terephthalatealdehyde, epichlorohydrin, vinyl acrylate, an aminosilane cross-linking agent, and combinations thereof.

15. The method of any of claims 13-14, wherein the hydrophilic polymer comprises a polymer selected from the group consisting of polyvinylalcohol, polyvinylacetate, polyethylene oxide, polyvinylpyrrolidone, polyacrylamine, and copolymers thereof, or blends thereof.

16. The method of any one of claims 8-15, wherein the selective polymer matrix comprises an amine-containing polymer.

17. The method of claim 16, wherein the amine-containing polymer is selected from the group consisting of polyamidine, polyguanidine, polyvinylamine, polyallylamine, polyethylenimine, poly-N-isopropylallylamine, poly-N-tert-butylallylamine, poly-N-1,2-dimethylpropylallylamine, poly-N-methylallylamine, poly-N,N-dimethylallylamine, poly-2-vinylpiperidine, poly-4-vinylpiperidine, polyaminostyrene, chitosan, copolymers, and blends thereof.

18. The method of any of claims 8-17, wherein the selective polymer matrix comprises a hydrophilic polymer, a cross-linking agent, amine-containing polymer, and a mobile carrier.

19. The method of any of claims 7-18, wherein the support layer comprises a gas permeable polymer.

20. The method of claim 19, wherein the gas permeable polymer comprises a polymer chosen from polyamides, polyimides, polypyrrolones, polyesters, sulfone-based polymers, nitrile-based polymers, polymeric organosilicones, fluorinated polymers, polyolefins, copolymers thereof, and blends thereof.

21. The method of claim 20, wherein the gas permeable polymer comprises polyethersulfone or polysulfone.

22. The method of any of claims 7-21, wherein the support layer comprises a gas permeable polymer disposed on a base.

23. The method of claim 22, wherein the base comprises a non-woven fabric.

24. The method of claim 23, wherein the non-woven fabric comprises fibers formed from a polyester.

25. The method of any of claims 1-24, wherein the facilitated transport membrane is configured in a flat sheet, a spiral-wound, a hollow fiber, or a plate-and-frame configuration.

26. The method of any of claims 1-25, wherein the sorbent comprises a physisorbent.

27. The method of any of claims 1-26, wherein the sorbent comprises a MOF-based physisorbent (e.g., KAUST-7, HKUST-1, MIL-101, etc.), a zeolitic imidazolate framework, a zeolite, activated carbon, or a combination thereof.

28. The method of any of claims 1-27, wherein the sorbent has a CO₂N₂ selectivity of at least 2 at 25° C. and 1 atm feed pressure.

29. The method of any of claims 1-28, wherein the gas stream comprises CO₂ at a concentration in the range of from 1-1000 ppm (e.g., air).

30. The method of any of claims 1-29, wherein desorbing the carbon dioxide from the sorbent to generate a CO₂-enriched gas stream comprises contacting the sorbent with steam.

31. A system for direct air capture of carbon dioxide, the system comprising:
a blower configured to direct a gas stream comprising carbon dioxide (e.g., air) to a DAC adsorber;
a DAC adsorber comprising a sorbent;
and a facilitated transport membrane disposed to contact and separate a CO₂-enriched gas stream desorbed from the sorbent present in the DAC adsorber.
